(19) United States
(12) Patent Application Publication
(10) Pub. No.: US 2002/0093485 A1
(43) Pub. Date: Jul. 18, 2002

(54) Heated computer pointing device

(76) Inventor: Harry G. Pappas, Saugus, MA (US)

Correspondence Address: MORSE, ALTMAN & MARTIN, P.O. BOX 6926, BOSTON, MA, 02102, US

(21) Appl. No.: 10/094,698

(22) Filed: Mar. 11, 2002

(51) Int. Cl. G09G 5/08

(52) U.S. Cl. 345/163; 345/167

(57) ABSTRACT

A computer pointing device with an internal heating element adjacent to the housing surface on which the user's hand rests. The heating element is any electrical device that can fit inside the pointing device and heat the mouse outer surface. The heating element is powered by an external transformer, the pointing device interface to the computer, a battery, or combinations thereof. Optionally, the pointing device includes a heating element current controller or a temperature controller.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to computer peripherals devices, more particularly, to computer pointing devices that provide internal heating for hand comfort.

2. Description of the Related Arts

Nearly every personal computer in use today has some kind of pointing device, such as a mouse, trackball, touch pad, joystick, pen, etc., for positioning a cursor on the display screen. For many computer uses, the pointing device is used relatively often but for short durations. For example, a user will position the cursor with the pointing device and then use both hands to type. A short time later, the user will use the pointing device to move the cursor again, and again use both hands to type. For other computer uses, the pointing device is in constant use, for example, when using a drawing program.

When using some pointing devices, such as a mouse or trackball, the user's hand rests on the device so that a substantial portion of the user's hand is in contact with the device. When used sporadically as described above, the mouse or trackball does not have a chance to warm up, and may be uncomfortably cold to the touch. When used continuously by people with circulatory or other problems of the hand, or for those people working in offices that are overly cool, the pointing device may be uncomfortably cold most of the time. In the remainder of this specification, unless indicated otherwise, the term “mouse” will refer collectively to mice, trackballs, and any other computer pointing device that the user's hand rests on while in use.

### BRIEF SUMMARY OF THE INVENTION

An object of the present invention is to provide a computer pointing device with internal heating to warm the surface on which the user's hand rests.

The present invention is a computer pointing device, such as a mouse or trackball, having a housing with an outer surface on which a user's hand rests during use, an electrical heating element within the housing for heating the outer surface, and a power source for the heating element. Optionally, the present invention includes a control for adjusting the heat provided. The heating element is one or more electrically resistive devices located adjacent to the outer surface of the pointing device where the user's hand rests while in use. The heating element is any device that can fit inside the pointing device and heat the mouse outer surface. Examples include discrete power resistors, embedded resistive conductors, polymer heaters, thick film heaters, and printed resistive materials.

The present invention contemplates several different possible power sources for the heating element, including an external transformer that plugs into a wall socket, the pointing device interface to the computer, or a battery. The present invention also contemplates that different power sources can be combined.

Optionally, the present invention includes a current controller for controlling the amount of current to the heating element, in turn, controlling the amount of heat applied to the outer surface. The current controller may be either external or internal to the pointing device. Optionally, the present invention includes a temperature controller for accurate regulation of the temperature of the pointing device outer surface.

Other objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a perspective view of a typical computer mouse incorporating some aspects of the present invention;

FIG. 2 is a perspective view of a typical computer trackball incorporating some aspects of the present invention;

FIG. 3 is an electrical schematic diagram of a basic heating circuit of the present invention;

FIG. 4 is an exploded, perspective view of a mouse incorporating some aspects of the present invention; and

FIG. 5 is an electrical schematic diagram of a basic temperature-controlled heating circuit for use by the present invention.

### DETAILED DESCRIPTION OF THE INVENTION

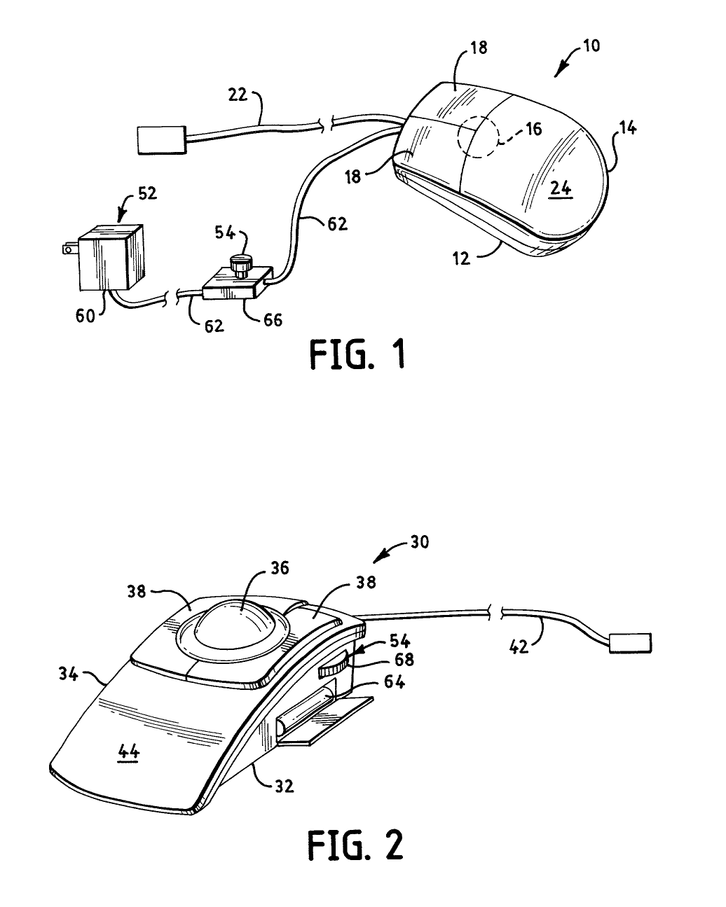

The vast majority of desktop computers incorporate a mouse as a pointing device. The typical mouse 10, shown in FIG. 1, includes a base 12, a cover 14, a ball 16 extending through the base 12 that rotates as the mouse 10 is moved, one or more buttons 18, and a wired 22 or wireless interface to the computer. When in use, the palm of the user's hand rests on the outer surface 24 of the mouse 10.

The typical trackball 30, shown in FIG. 2, includes a base 32, a cover 34, a ball 36 extending through the cover 34 that is rotated by the user, one or more buttons 38, and a wired or wireless interface 42 to the computer. The palm of the user's hand rests on the outer surface 44 of the trackball 30.

Unless indicated otherwise, references to the mouse 10 will, by definition, include the corresponding components of the trackball 30 and any other computer pointing device that the user's hand rests on while in use.

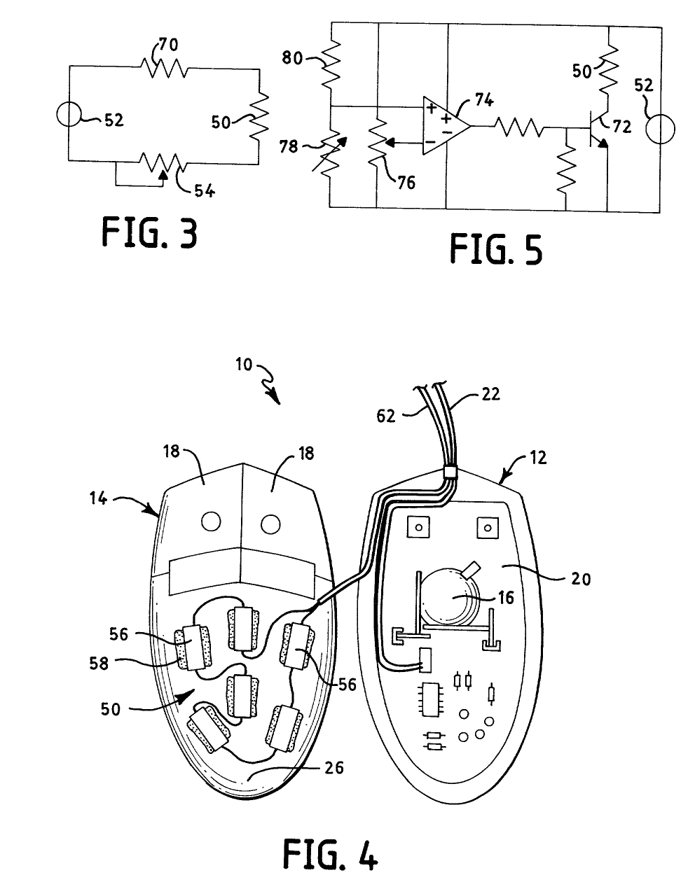

A basic electrical schematic of the present invention is shown in FIG. 3. It includes a heating element 50, a power source 52, an optional temperature control 54, and an optional limiting resistor 70. The individual components are discussed below.

The heating element 50 provides heat to warm the outer surface 24 of the mouse 10. The heating element 50 consists of one or more electrically resistive devices that convert electric current to heat. Any device that fits inside the mouse 10 and can heat the mouse outer surface 24 is contemplated for use as the heating element 50 by the present invention. Examples of such devices include discrete power resistors, embedded resistive conductors, polymer heaters, thick film heaters, and printed resistive materials.

In one configuration, shown in FIG. 4, the heating element 50 consists of a set of power resistors 56 wired in series. One example is a set of six 20 Ω, 1 watt resistors. The resistors 56 are bonded to the inner surface 26 of the mouse cover 14 so that good heat transfer from the resistors 56 to the mouse outer surface 24 is achieved. Bonding is done in whatever manner is appropriate for the components, for example, with an epoxy, as at 58. Alternatively, the resistors 56 are molded to or molded into the mouse cover 14.

In another configuration, the heating element 50 is a resistive conductor molded or otherwise embedded within the mouse cover 14. The resistive conductor can be arranged to uniformly cover the outer surface 24 so that the heat is more uniformly distributed than is likely with several discrete power resistors. The use of embedded resistive conductors facilitates providing heat to more than just the portion of the mouse cover 14 on which the hand rests. It is much easier to provide heated mouse buttons 18 as well because the resistive conductors can be fashioned as necessary to be embedded in the buttons 18.

In another configuration, the heating element 50 is a polymer device molded to fit against the inner surface 26 of the mouse cover 14, or to replace the mouse cover 14 entirely. Polymer heating elements combine resistive heating elements with thermoset and/or thermoplastic compounds to yield a component that incorporates the heating element into the structure. Polymer heating elements can be molded by various techniques, including compression, injection, and thermoform. Like the embedded resistive conductor described above, polymer heating elements facilitate providing heat to more than just the portion of the mouse cover 14 on which the hand rests. It is much easier to provide heated mouse buttons 18 as well because polymer heating elements can be molded to replace the typical mouse buttons.

In another configuration, the heating element 50 consists of a resistive material or paste printed onto a shaped substrate that is attached to the inner surface 26 of the mouse cover 14. Alternatively, the resistive material or paste is printed directly onto the inner surface 26 of the mouse cover 14 without the use of a separate shaped substrate. Again, heated mouse buttons can be more easily provided by this method.

The present invention contemplates that the heating element 50 will be powered from a power source 52 that is one or more of at least three types. The first is an external plug-in transformer 60, as shown in FIG. 1. The typical transformer 60 is a standalone device that plugs into a standard wall socket and converts the alternating current power to a direct current suitable for use by the heating element 50. Direct current is preferred so as to minimize noise in the mouse circuitry 20. This does not preclude the use of alternating current, provided that the mouse circuitry 20 is not adversely affected. A power cable 62 runs from the transformer output to either a control box, as in FIG. 1, or directly to the mouse 10. Optionally, the power cable 62 will have a plug that fits into a jack in the mouse 10 so that it may be easily disconnected for storage, shipment, or replacement. In the current implementation, the transformer 60 outputs 15 volts of direct current (VDC) at a maximum of 800 milliamperes (mA) for a total of 12 watts. The necessary output capabilities of the transformer will depend on the particular application and the parameters of the heating element 50. The significant advantage to an external transformer 60 is that, unlike other power sources described below, there are no real limitations regarding the amount of power available for the heating element 50. The significant disadvantage is that there is at least one component, the transformer 60, that is external to the mouse 10.

The second contemplated type of power source is the interface 22 through which the mouse 10 is connected to the computer. The concern here is that the interface 22 is capable of supplying enough power. For example, a Universal Serial Bus (USB) interface can only be expected to provide up to 500 mA at 4.25 VDC, for a total of 2.12 watts. Keeping in mind that the mouse circuitry 20 requires some of this power, the remainder of the 2.12 watts may or may not be enough to power the heating element 50.

The third contemplated type of power source is a battery 64, either internal, as in FIG. 2, or external. Trade-offs must be made between the amount of heat desired, battery size, battery life, and convenience. Obviously, an external battery can be larger, thus longer lasting, than an internal battery, but is less convenient due to the external housing necessary.

The present invention contemplates that the mouse 10 can make use of a combination of power sources. For example, interface and battery powers can be combined such that the battery augments the interface power and the interface allows for a reduced battery size and/or extended battery life. In another example, a rechargeable battery can be used that may be recharged by interface power when the heating element 50 is not in use or may be recharged by an external transformer.

The mouse 10 of the present invention optionally includes a current controller 54, a variable resistor or rheostat control for allowing the user to control the amount of current to the heating element 50, in turn, controlling the amount of heat applied to the outer surface 24. In one configuration, the current controller 54 is in a box 66 external to the mouse, as in FIG. 1. In another configuration, the current controller 54 is internal to the mouse 10, as in FIG. 2. Any configuration that allows the user access to the current controller 54 when desired is contemplated. The accessibility of the current controller 54 will, in part, depend on how often it needs to be adjusted. For example, if the current controller 54 requires regular adjustment, it may be made easily accessible as a rotating dial 68 protruding from the side of the mouse, as in FIG. 2. If the current controller 54 requires infrequent adjustment, it may be located behind an aperture and adjustable by a screwdriver or it may be a dial hidden behind a hatch in the mouse 10.

The electric circuit optionally includes a limiting resistor 70 that prevents the circuit from attempting to draw more current than the power source 52 can provide.

One limitation of the simple circuit of FIG. 3 is that there is no true temperature control. Because of external factors, such as the current room temperature and heat from the user's hand, a simple current adjustment does not provide for an accurate temperature setting. The present invention optionally includes a temperature sensor for controlling the heating element current. The simple circuit of FIG. 5 can be used to provide temperature control. The heating element 50 is switched on and off by a transistor 72, and the transistor 72 is controlled by a comparator 74. One input to the comparator 74 is a temperature setting control 76, and the other input is a temperature-sensitive component 78, that is, a component that changes resistance with temperature. The voltage at the junction of temperature-sensitive component 78 and a fixed resistor 80 changes with the temperature. As the voltage drops below that set by the control 76, the comparator 74 switches the transistor 72 on, applying power to the heating element 50. The circuit of FIG. 5 is merely an example of a temperature control circuit. The present invention contemplates the use of any temperature control circuit that performs as desired.

Thus it has been shown and described a heated pointing device which satisfies the objects set forth above.

Since certain changes may be made in the present disclosure without departing from the scope of the present invention, it is intended that all matter described in the foregoing specification and shown in the accompanying drawings be interpreted as illustrative and not in a limiting sense.

I claim:

1. A pointing device adapted for use with a computer, said pointing device comprising:
(a) a housing having an outer surface on which a user's hand rests while using said pointing device;
(b) an electrical heating element within said housing for heating said outer surface; and
(c) a power source for said heating element.

2. The pointing device of claim 1 wherein said heating element is at least one power resistor bonded to an inner surface of said housing adjacent to said outer surface.

3. The pointing device of claim 1 wherein said heating element is embedded in said housing adjacent to said outer surface.

4. The pointing device of claim 1 wherein said heating element is a resistive material adhered to a shaped substrate, said substrate being attached to an inner surface of said housing adjacent to said outer surface.

5. The pointing device of claim 1 wherein said pointing device includes a current control for controlling the current to said heating element.

6. The computer pointing device of claim 5 wherein said current control is internal to said housing.

7. The pointing device of claim 5 wherein said current control is external to said housing.

8. The pointing device of claim 1 wherein said pointing device includes a temperature control for controlling the temperature of said outer surface.

9. The computer pointing device of claim 8 wherein said temperature control is internal to said housing.

10. The pointing device of claim 8 wherein said temperature control is external to said housing.

11. The pointing device of claim 1 wherein said power source is a battery.

12. The pointing device of claim 1 wherein said power source is an external transformer.

13. The pointing device of claim 1 wherein said pointing device has an interface adapted to mate with said computer, and said power source is said interface.
